(19) United States
(12) Patent Application Publication
(10) Pub. No.: US 2021/0004790 A1
(43) Pub. Date: Jan. 7, 2021

(54) Systems, Methods and Devices for Providing Automated Adaptive Web-Based News Feeds

(71) Applicant: DECENTRAL INC., Toronto (CA)

(72) Inventor: ANTHONY DI IORIO, TORONTO (CA)

(21) Appl. No.: 16/503,252

(22) Filed: Jul. 3, 2019

(51) Int. Cl. G06Q 20/36; G06F 16/951; G06Q 20/38; G06Q 20/06

(52) U.S. Cl. CPC G06Q 20/3678; G06F 16/951; G06Q 2220/00; G06Q 20/0658; G06Q 20/389

(57) ABSTRACT

There is provided a system and method for facilitating automatic customized web feed generation via an aggregator server, the server having a processor, a communication subsystem and a memory each in communication with the processor, the memory storing instructions, which when executed by the processor, configure the aggregator server to: communicate with a plurality of web feed sources to request and retrieve web feeds of a plurality of web sites having web pages; aggregate the web feeds from the plurality of web feed sources and web sites into an aggregated web feed; automatically scan web content of each web page within the aggregated web feed and tag each web page within the aggregated web feed having a pre-defined degree of relevance of information pertaining to at least one pre-defined cryptocurrency to a corresponding at least one cryptocurrency identifier; store mapped sets of each tagged web page and corresponding to least one cryptocurrency identifier in a database of the aggregator server; automatically receive an indication from a computing device of a listing of cryptocurrency assets held by a user of the computing device, said indication indicating an automatic request for web feed information relating to said listing of cryptocurrency assets; automatically provide a custom web feed to the computing device, the custom web feed comprising content from each tagged web page having a corresponding at least one cryptocurrency identifier which exists within the listing of cryptocurrency assets, the custom web feed for subsequent display on the computing device for being associated with the listing of cryptocurrency assets.

### FIELD

This disclosure relates to providing and distributing content from web news feeds and in particular, to systems, methods and devices for dynamically and adaptively selecting and displaying the digital content to a client device based on the asset(s) in the client device's digital wallet(s) which facilitate secure electronic transactions including purchases of cryptocurrencies.

### BACKGROUND

There are various known manners to provide news personalization on mobile devices. Among these, content providers and/or service providers can provide content to a user by the use of Really Simple Syndication or Rich Site Summary (RSS) feeds (see RSS feed description at https://en.wikipedia.org/wiki/RSS) and also RSS Specifications at https://validator.w3.org/feed/docs/rss2.html), Atom (See Request For Comment RFC4287 at https://validator.w3.org/feed/docs/rfc4287.html from the Internet Engineering Task Force (IETF)), and the like.

For example, RSS is an XML-based technology for publishing information on the Internet mainly targeted at frequently-changing information such as weather, news, stocks, etc. Typically, a user subscribes to an RSS feed to view up-to-date information relating to a defined category or type of information. For example, a user can subscribe to an RSS feed showing “World News” from one or more news provider websites. Notably, an RSS feed can be subscribed to by a user to receive and keep track of new information posted on web pages of a particular website (push model) rather than having to explicitly visit the website (pull model). In practice, a user can register with a news aggregator, a type of content provider that provides information via a browser or application interface and specifically indicate (e.g. subscribe to) one or more web feeds, e.g. RSS feeds for various websites of interest to track. Thus, users only receive updates from websites which they have manually pre-selected (e.g. by manually defining topics of interest).

Generally speaking, although web feeds and web feed readers have facilitated the ability to quickly browse and receive updates from a number of web pages, such pre-defined feed sources have limited flexibility as they require manual user input and intervention to define websites/topics of interest and significant effort for a user to continually review the news feed subscription to determine whether they are still relevant to the user. Additionally, the web feeds can quickly become disorganized and chaotic as more feeds are manually added by a user. If the user's needs or interests change over time, the user then manually updates their preferences (e.g. via the web feed aggregator either online or via a mobile application) in order to receive newly-requested website content updates. This activity can be tedious, time-consuming and inaccurate. When updating preferences is delayed, undesired content may be selected and transmitted to the user thereby wasting computing and communication resources.

More specifically, the cryptocurrency space has a torrent of news being generated on a daily basis. However, most of the web information is irrelevant and superfluous to most users of cryptocurrency.

### SUMMARY

Thus, there exists a need to automatically deliver customized dynamic and adaptive web-based news feeds to a user's computing device(s) such as feeds based on cryptocurrency assets (e.g. bitcoin), which a user owns. There is disclosed a method of determining one or more digital assets held in a digital wallet of a user on a computing device; automatically requesting a web-based news feed relating to the one or more digital assets from a feed aggregator server across a communication network; obtaining said news feed indicating a notification of a change to at least one website having content associated with at least one of said digital assets and in response to the request; alerting the user to the change at the website thereby displaying at least a portion of said news feed on a user interface of the computing device. The computing device may be for example, a mobile device, a desktop, or a cell phone.

In one aspect, there is provided an aggregator server for facilitating automatic customized web feed generation, the server having a processor, a communication subsystem and a memory each in communication with the processor, the memory storing instructions, which when executed by the processor, configure the aggregator server to: receive web feeds of items of content from a plurality of web feed sources and web sites; automatically scan the content of each item within the web feeds and tag each item in accordance with a relation in the content to one or more pre-defined cryptocurrencies; automatically receive from a computing device a request for web feed information associated with a listing of cryptocurrencies, the listing determined from cryptocurrency assets managed by the computing device in association with a user of the computing device; automatically define a custom web feed to comprise items selected from each item as tagged and responsive to the listing of cryptocurrencies; and automatically communicate the custom web feed to the computing device in response to the request.

In yet another aspect, there is provided a mobile device configured for facilitating automatic customized web feed generation, the mobile device having a processor, a communication subsystem and a memory each in communication with the processor, the memory storing instructions, which when executed by the processor, configure the mobile device to: automatically determine cryptocurrency types held by a user's account in a digital wallet application, stored by the mobile device, for cryptocurrency related transactions; provide a listing of the cryptocurrency types to an aggregator server thereby automatically subscribing to news feed having items of content relating to said cryptocurrency types; and display the news feed on a user interface of the mobile device.

In yet another aspect, there is provided a computer-implemented method for facilitating automatic customized web feed generation, the method comprising: communicating with a plurality of web feed sources and web sites to request and retrieve web feeds of items of content; automatically scanning the content of each item within the web feeds and tagging each item in accordance with a relation in the content to one or more pre-defined cryptocurrencies; automatically receiving from a computing device a request for web feed information associated with a listing of cryptocurrencies, the listing determined from cryptocurrency assets managed by the computing device in association with a user of the computing device; automatically defining a custom web feed to comprise items selected from each item as tagged and responsive to the listing of cryptocurrencies; and automatically communicating the custom web feed to the computing device in response to the request.

In yet another aspect there is provided an adaptive web based news feed system for automatically providing a customized web news feed related to digital assets held by a user of a computing device, the system comprising: an aggregator server configured to automatically subscribe the computing device to a custom news feed having content relating to cryptocurrency types specified in a listing of cryptocurrency assets and to update the custom news feed based upon a second listing of the cryptocurrency types provided at a subsequent time; and the computing device configured to: automatically determine cryptocurrency types held by a user's account in a digital wallet application, stored by the computing device, for cryptocurrency related transactions; and provide a listing of the cryptocurrency types to the aggregator server.

These and other aspects will be apparent including computer program products which store instructions in a non-transient manner (e.g. in a storage device) which when executed by a computing device configure the device to perform operations as described herein.

### BRIEF DESCRIPTION OF THE DRAWINGS

FIG. 1 is a schematic block diagram of a computing system for providing dynamic and adaptive news feeds (e.g. using RSS feeds) to a computing device, in accordance with an embodiment.

FIG. 2 is a schematic block diagram of a client computing device of FIG. 1, in accordance with an embodiment.

FIG. 3 is a schematic block diagram of an aggregator server (a type of computing device) of FIG. 1 providing dynamic and adaptive web news feeds to the client computing device of FIG. 1 and FIG. 2 in accordance with an embodiment.

FIG. 4 is a flowchart showing operations of the aggregator server for the computing system of FIG. 1, in accordance with an embodiment.

FIG. 5 is a flowchart showing operations of the client computing device of FIG. 2, in accordance with an embodiment.

While references to “an embodiment” are used herein, nothing should be implied or understood that features of one embodiment cannot be used or combined with features of another embodiment unless otherwise stated. The various systems, methods and devices shown and described herein may be used together unless otherwise stated.

### DETAILED DESCRIPTION

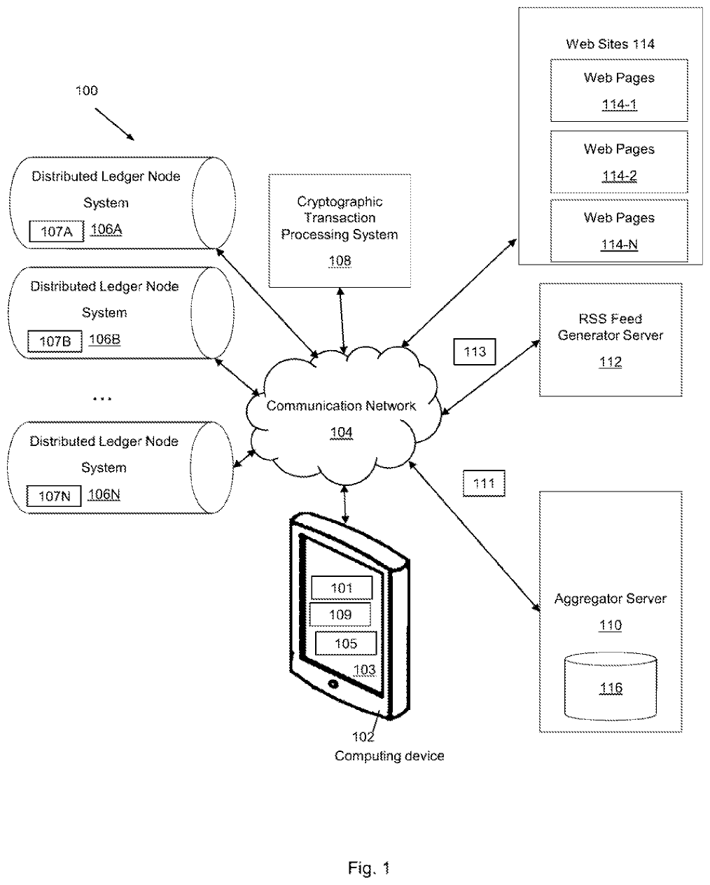

FIG. 1 depicts a block schematic diagram of a computing system 100 for providing adaptive web-based news feeds (e.g. RSS feed, ATOM feed or the like) to a computing device 102, in accordance with an embodiment. Feeds can include by way of example but not limitation, RSS feeds, Atom, JSON, raw XML, etc. The computing system 100 comprises a number of computing components such as computing device(s) 102 and website(s) 114, Feed Generator Server 112, cryptographic transaction processing system 108, distributed ledger node system(s) 107A . . . 107N in communication with one another across a communication network 104 (e.g., the Internet). Components include a client computing device 102 having an optical output device (e.g. display screen 103). Client computing device 102 further comprises software applications, including a web news application module 101 for processing and displaying web feeds, a web browser module 109, and a digital multi-coin/multi-asset digital wallet module 105.

The computing device 102 is in communication with an intermediate cryptographic transaction processing system 108 which communicates respective cryptocurrency related transactions on behalf of client computing device 102 to respective distributed ledger node systems 106A, 106B, . . . 106N that respectively maintain distributed ledgers 107A, 107B, . . . 107N for respective cryptocurrencies. For simplicity, a distributed ledger node system (e.g. 106A) maintains one distributed ledger (e.g. 107A) and one cryptocurrency but such a system but could be configured to provide more than one distributed ledger such as for more than one cryptocurrency. Each distributed ledger node system (e.g. 106A, 106B, . . . 106N) and distributed ledger (e.g. 107A, 107B . . . 107N) represent a public blockchain which typically comprises a plurality of distributed computing nodes (each node is a computing device 102, not illustrated) operating together to provide the blockchain (i.e. one of the distributed ledgers 107A, 107B . . . 107N). The blockchain stores distributed ledger data in blocks. Examples of such blockchains include the Bitcoin blockchain and the Ethereum blockchain which the unit is Ether™. Each distributed ledger node system 106A, 106B, . . . 106N comprises many nodes, each with a copy of the ledger and is shown in a simplified manner in FIG. 1. In at least some embodiments, the cryptographic transaction processing system 108 may be omitted such that the wallet module 105 communicates directly with a respective distributed ledger node system 106A, 106B, . . . 106N in respect of a respective cryptocurrency.

According to the illustrated embodiment, each client computing device 102 may be configured to perform digital transactions via intermediate cryptographic transaction processing system 108 with more than one respective distributed ledger (e.g. blockchain) of the plurality of different distributed ledgers 107A, 107B, . . . 107N (e.g. blockchains).

FIG. 1 further illustrates other components of the computing system 100 for providing news feeds to the computing device 102. Such news fees are based on cryptocurrency transaction(s) related to the computing device 102 and particularly, cryptocurrency assets associated with a particular cryptocurrency (e.g. bitcoin) owned by a user of the computing device 102 as contained in the digital wallet module 105. Such cryptocurrency assets are associated with respective public transaction addresses on respective distributed ledgers 107A, 107B . . . 107N). These further components of FIG. 1 include web pages 114-1, 114-2 to 114-N (collectively, web site(s) 114), an aggregator server 110, a web-based news feed generator server (e.g. RSS feed generator server 112) communicating across the communication network 104 with one another and with the computing device 102. Such communications further include communication with browser module 109 and/or web news application module 101 for accessing the customized news feed 111 provided by the aggregator server 110.

In operation, the aggregator server 110 requests and retrieves a pre-defined set of RSS (or other news stream) feeds from the news feed generator server (e.g. RSS feed generator server 112). In general, the RSS feed generator server 112 is configured to monitor the web sites 114 over the communication network 104, which may be the Internet, to determine whether changes have been made to associated web pages. The web sites 114 may be associated with pre-defined preferences of various subscribers to the online news aggregator, according to known RSS feed aggregation techniques. The web sites 114 in co-operation with the RSS feed generator server 112 may provide RSS feeds 113 for notifying third parties such as the aggregator server 110, of changes/updates in content to the web sites 114. In one aspect, the aggregator server 110 may be combined with the RSS feed generator server 112 as a single entity. Additionally, the aggregator server 110 may be a software application program residing on the computing device 102.

The aggregator server 110 is configured to frequently retrieve and download pertinent RSS feeds 113 from the RSS feed generator server 112 (e.g. at pre-defined times or upon a receiving a trigger, e.g. from the computing device 102) and merges the feeds to represent as an aggregated representation (e.g. a single news feed). The aggregator server 110 is further configured to automatically search (e.g. filter) and tag relevant items in RSS feeds 113 received. The tagged items in the customized news feed 111 are provided using either regular expressions and/or a machine learning model that analyzes the data in the feed to assign each web site or items of web content (e.g. news article) in the received feed 113 to one or more pre-defined cryptocurrency identifiers stored in an associated database 116. For example, machine learning may be used to determine the relevance of a particular cryptocurrency coin mentioned in a news article provided by the web sites 114 and only tag the web article with the particular cryptocurrency symbol if the news article adequately relates to the particular cryptocurrency. This can include for example, performing a count to determine if a pre-defined number of mentions within the article for the particular cryptocurrency is met or exceeded, by using semantic analysis, or in another manner of classification, etc. . . . . A single article from a feed 113 may be tagged with more than one symbol should it relate in its content to more than one cryptocurrency. Machine learning within the aggregator server 110 may also be adapted to tag a web article as relating to a particular cryptocurrency if the web article inferentially relates to the cryptocurrency (e.g. inferential mention rather than literal mention of the cryptocurrency which may occur by the database 116 storing topics associated to the cryptocurrency). A user of the computing device 102 may also be able to define the degree of correlation desired between a news article received in the customized news feed 111 and the cryptocurrency utilizing a GUI of the computing device 102, which communicates with the aggregator server 110. In one aspect, said degree of expected correlation is stored within the database 116 for subsequent use in tagging by the aggregator server 110 between a news feed and a cryptocurrency identified in the feed.

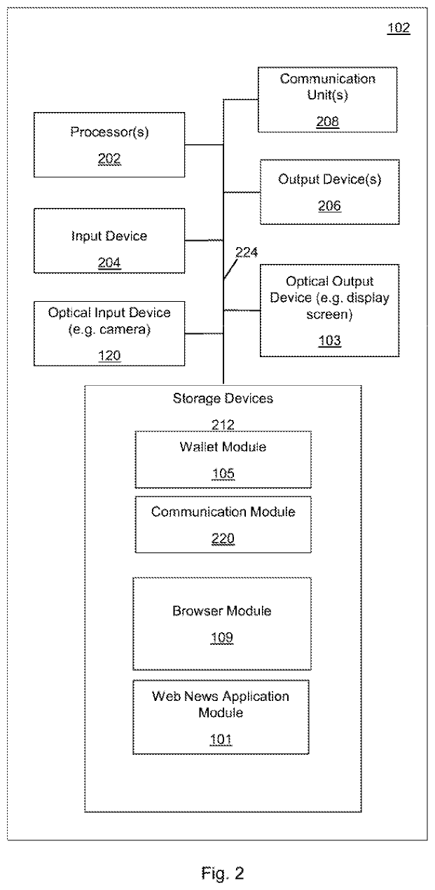

In turn, the computing device 102 is configured to automatically determine which digital assets (e.g. cryptocurrency types) are held by the user's account in the wallet application, e.g. digital wallet module 105. For example, the computing device 102 may check the cryptocurrencies held in the wallet module 105 periodically and/or be triggered to check by detecting a cryptocurrency transaction performed by the wallet module 105 and/or be triggered by a user of the computing device 102 to check each of the cryptocurrencies held and their value. The wallet module 105 as also shown in FIG. 2 is a software program/application for managing digital assets via the computing device 102 and specifically relates to a wallet that is configured to manage many different digital assets in a single interface.

A cryptocurrency wallet such as wallet module 105 is a secure digital wallet (e.g. software program as shown in FIG. 2) used to store, send and receive digital cryptocurrencies. The wallet module 105 stores private and public keys and interacts with respective blockchains (e.g. distributed ledgers 107A, 107B . . . 107N) to enable users to send and receive digital cryptocurrency and monitor their balance(s). As discussed herein, the wallet module 105 is a universal wallet/multi-coin wallet, which can be used to store many different types of cryptocurrency coins. The wallet module 105 may be operable online or offline for at least some operations (e.g. would require connecting online in order to perform any transactions and/or check balances and/or exchange information over the communication network 104). The wallet module 105 may be a “hot wallet” (e.g. a wallet connected to the Internet) or a “cold wallet” (e.g. a hardware wallet unplugged and in a safe). For example, a user may choose to store long term funds in “cold storage” in an offline wallet. A function of a wallet is to identify the transaction addresses to which a user has access to and thus owns the addresses. For example, the addresses are communicated to an intermediate device that does have connectivity. Preferably, that communication is highly secure, such as the air-gapped optical I/O devices (i.e. QR code display/read) approach.

The wallet application (e.g. wallet module 105) is usually configured to periodically check cryptocurrency balance information for the transaction addresses managed by the wallet. Typically, the balance for each of the digital assets is stored in the wallet module 105 and may be displayed on a GUI interface of the wallet module 105. The wallet application (e.g. wallet module 105) may be configured to communicate with cryptographic transaction processing system 108 (or another server (not shown) to obtain balance information from respective distributed ledgers 107A, 107B, . . . 107N. It is understood that for the general purposes of providing dynamic and adaptive web-based news feeds to a user's computing device(s) 102, having 100% accurate balance information at any given instance is not absolutely necessary. Transactions may be pending on a respective blockchain and current balance information may be relative to previously competed transactions and not those pending completion. However, for the purposes of feeding news related to a cryptocurrency of interest, such a balance may remain useful even if not 100% current.

Once the computing device 102 determines the digital assets (cryptocurrencies) held and currently owned by the user (e.g. cryptocurrencies A to N) in the wallet module 105, the wallet module 105 automatically provides the listing of said cryptocurrency (e.g. bitcoin) held by the user (e.g. having a valued balance greater than zero) to the aggregator server 110 and thereby automatically subscribes to and requests web news (e.g. web sites 114) from the aggregator 110 that relates specifically to the user-owned digital cryptocurrencies (e.g. cryptocurrencies A to N). In response, the aggregator server 110 generates the automatic and adaptively subscribed customized news feed 111 based on the current wallet module 105 balance status. In one example, the aggregator server 110 provides an interface to its users for reading the feeds to which they automatically subscribe. The interface may be an online website accessed by browser module 109 or alternatively a software application (e.g. the web news application module 101 shown in FIG. 2) on the computing device 102. The interface may be provided for displays via display screen 103. The interface may include sound such as to make the feed audible (e.g. reading the news) via a speaker (not shown) of computing device 102.

As illustrated above, the aggregator server 110 provides a news stream (e.g. RSS, Atom, JSON, or raw XML feed) that relates to the user's specific digital asset holdings in the wallet module 105. As will be understood, as the cryptocurrencies owned in the wallet module 105 change over time, the computing device 102 automatically and dynamically updates the digital subscription (e.g. to various websites) such that only the web news feed(s) that are tagged by the aggregator server 110 as being associated with a currently owned cryptocurrency in wallet module 105 are provided as customized news feeds 111 to the computing device 102 (e.g. for display on the display screen 103).

Conveniently, this automatic and tailored news subscription feed system depicted in FIG. 1, provides relevant and up-to date web feed information to a user of the computing device 102. In this manner, extraneous and superfluous web feeds that are irrelevant to a user are not received by the computing device 102. This reduces the amount of data received on the computing device 102 and communicated across the communication network 104, thereby improving efficiency, bandwidth, storage needs and battery usage. Additionally, although a single computing device 102 is shown, the concept can extend to multiple computing devices 102 such that each user of a corresponding digital wallet module 105 receives a different web feed stream that is customized to the user (e.g. mass personalization via automated customization of the feeds). Additionally, since the embodiments described herein are to be used with a wallet module 105 configured to contain many different digital cryptocurrency assets, the RSS feed generator server 112 cooperates with the aggregator server 110 to provide tailored news feed updates relevant to the multiple digital cryptocurrency assets. Such a disclosed system and method avoids deficiencies in prior art systems where a user needs to manually subscribe to topics of interest from an RSS feed (which can quickly become chaotic to navigate) and difficult to subsequently maintain and update as the topics of interest grow.

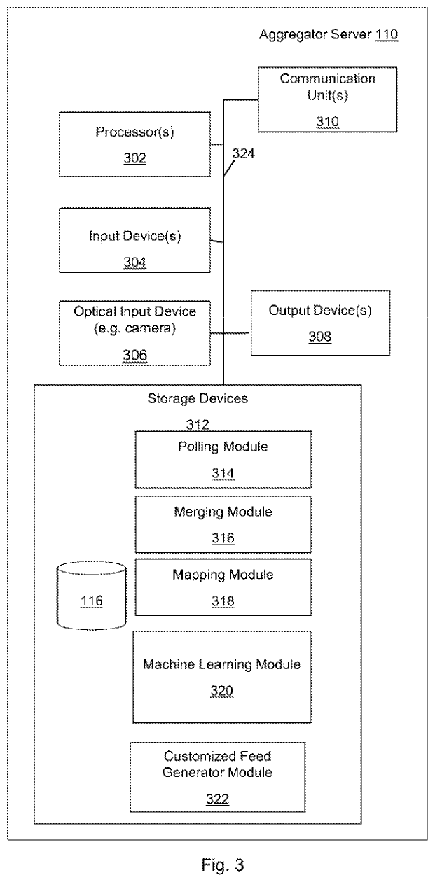

In one embodiment, a user of the computing device 102, may be presented with additional options to further customize content of the received aggregated customized news feeds 111 (e.g. via a web news application module 101). For example, the user can, via an interface of the web news application module 101, unsubscribe to one or more topics of conversation (e.g. relating to digital assets in web content) such as web-based news articles or web sites 114 provided in the received customized news feeds 111. In turn, this triggers the machine learning module 320 (see FIG. 3) within the aggregator server 110 to re-adjust and re-calibrate how news feeds are automatically tagged to the particular cryptocurrency asset associated with the recently unsubscribed news feed article/web page.

FIG. 2 is a block schematic diagram of a client computing device 102 of FIG. 1 in accordance with an embodiment. As illustrated, the client computing device 102 comprises one or more processors 202, one or more input devices 204 as well as an optical input device 120. Input devices may be a keyboard, a key pad, buttons, pointing device, microphone, etc. The optical input device 120 may comprise a camera or an IR sensor (receiver). If the optical input device 120 is an IR sensor, one of the input devices may be a camera. Client computing device 102 may have more than one camera. Client computing device 102 comprises one or more output devices 206 as well as at least one an optical output device. Output devices may include a speaker, light, bell, vibratory device, etc. An optical output device may be display screen 103 or an IR transmitter or a projector. Client computing device 102 may have more than one display screen 103. It is understood that a display screen 103 used in client computing device 102 may be configured as an input device as well, for example, a gesture based device for receiving touch inputs according to various known technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display).

Client computing device 102 further comprises one or more communication units 208 (e.g. Antenna, induction coil, external buses (e.g. USB, etc.), etc.) for communicating via one or more communication networks to one or more other computing devices, e.g. 110, 112, 114, 108, and 106.

Client computing device 102 further comprises one or more storage devices 212. The one or more storage devices 212 may store instructions and/or data for processing during operation of client computing device 102. The one or more storage devices may take different forms and/or configurations, for example, as short-term memory or long-term memory. Storage devices 212 may be configured for short-term storage of information as volatile memory, which does not retain stored contents when power is removed. Volatile memory examples include random access memory (RAM), dynamic random access memory (DRAM), static random access memory (SRAM), etc. Storage devices 212, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Storage devices 212 store instructions and/or data for client computing device 102, said instructions when executed by the one or more processors 202 configure client computing device 102 to perform various operation as described herein. Instructions may be stored as modules such as a wallet module 105 for performing cryptographic digital transactions (e.g. transfers of cryptocurrency and providing balance information), browser module 109 (e.g. for viewing web pages and/or for viewing online news feed data automatically subscribed to), web news application module 101 (e.g. for viewing the subscribed to online news feed data within a news application displayed on the display screen 103), optical input device 120, optical output device 103 and communication module 220. Communication module 220 may provide communications capabilities using communication units 208 to communicate with communication network 104 or other computing devices in a local or peer-to-peer network (not shown). Other modules are not shown such as an operating system, etc.

Wallet module 105 may implement a deterministic wallet and preferably a hierarchical deterministic (HD) wallet. Wallet module 105 may provide an implementation compliant with various Bitcoin Improvement Proposals (BIPs) such as BIP 32—Hierarchical Deterministic Wallets published at https://github.com/bitcoin/bips/blob/master/bip-0032.mediawiki; and BIP 39—Mnemonic code for generating deterministic keys published at https://github.com/bitcoin/bips/blob/master/bip-0032.mediawiki; each of which is incorporated herein by reference.

Communication channels 224 may couple each of the components 101, 103, 105, 109, 120, 202, 204, 206, 208, 212, and 220 for inter-component communications, whether communicatively, physically and/or operatively. In some examples, communication channels 224 may include a system bus, a network connection, an inter-process communication data structure, or any other method for communicating data.

In the examples herein, client computing device 102 is a mobile phone. Other examples of client computing device 102 may be a tablet computer, a personal digital assistant (PDA), a laptop computer, a tabletop computer, a portable gaming device, a portable media player, an e-book reader, a watch, a personal computer or workstation or another type of computing device.

FIG. 3 is a block diagram of an aggregator server 110 of FIG. 1, in accordance with an embodiment. As discussed above, the aggregator server 110 serves to poll, monitor and process a large collection of web information feeds (e.g. provided by one or more blog feeds such as RSS or ATOM feeds). Such feeds may be provided by the RSS feed generator server 112 and/or directly from web sites 114 in order to generate adaptive and customized news feeds 111 that are specific to a computing device 102 wallet's cryptocurrencies as shown in FIG. 1.

Aggregator server 110 comprises one or more processors 302, one or more input devices 304 as well as, optionally, an optical input device 306. Input devices may be a keyboard, key pad, buttons, pointing device, microphone, etc. In one example, the optical input device 306 may comprise a camera or an IR sensor (receiver). Aggregator server 110 may comprise one or more output devices 308. Output devices may include a speaker, light, bell, vibratory device, optical output device (e.g. a display screen) etc. It is understood that a display screen used in aggregator server 110 may be configured as an input device as well, for example, a gesture based device for receiving touch inputs according to various known technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display).

Similar to computing device 102, the aggregator server 110 may comprise one or more communication units 310 (e.g. Antenna, induction coil, external bus connectors (e.g. USB, etc.), etc.) for communicating with other computing component(s) (e.g. 102, 112, 114, 108, 106, 107) such as via one or more communication networks (e.g. 104) via communication channels 324. In some examples, communication channels 324 may include a system bus, a network connection, an inter-process communication data structure, or any other method for communicating data.

Aggregator server 110 further comprises one or more storage devices 312. The one or more storage devices 312 may store instructions (for execution by the processor(s) 302) and/or data for processing during operation of aggregator server 110 for generating customized, dynamic and real-time web feeds tailored to cryptocurrency transactions, and specifically cryptocurrency asset(s) held by a user of the computing device 102 via a customized feed generator module 322. The one or more storage devices may take different forms and/or configurations, such as described with reference to FIG. 2.

Storage devices 312 store instructions and/or data for aggregator server 110, which instructions when executed by the one or more processors 302 configure the aggregator server 110, as described herein. Instructions may be stored as modules such as a polling module 314 for monitoring and periodically polling a large number of web sites 114 and/or multiple defined web feeds 113 provided by the RSS feed generator server 112 to determine whether there are updates relating to the contents of the web feeds relating to pre-defined categories of information. Instructions may also be stored as merging module 316, which is configured to combine the contents of multiple web feeds (e.g. as triggered by the polling module 314 to be received via the RSS feed generator server 112). Further instructions are stored as a mapping module 318 and the machine learning module 320. The mapping module 318 is configured to automatically screen and tag each of the relevant news feeds received and provided by the merging module 316 with associated cryptocurrency tags or identifiers or keywords. By tagging each relevant news feed with the associated cryptocurrency tag(s), this indicate that the particular web feed(s) contain content for a particular cryptocurrency such as bitcoin. Screening each received news feed (e.g. by the mapping module 318) to determine associated cryptocurrency tags may involve using machine learning and classification pattern recognition techniques on the content of each received news feed (e.g. each article) as provided by the machine learning module 320. The web feed database 116 is a large categorized collection of previously classified web feeds mapped/tagged to one or more cryptocurrency related web feed identifiers. In one example, such a mapping may include web page content or links to webpages and other kinds of digital media mapped to one or more cryptocurrency tag(s). Yet further instructions are stored as a customized feed generator module 322 that is configured to receive information from the computing device 102 regarding specific digital cryptocurrency assets held by a user of the computing device 102. For example, the processors 202 of computing device 102 shown in FIG. 2 are configured to communicate with a cryptocurrency transaction processing system (e.g. 108 shown in FIG. 1) to obtain an inventory of cryptocurrency which is stored in the secure wallet module 105 on the computing device 102. The request may be received from an interface of the computing device 102 having a cryptocurrency wallet and address(es) relative to respective distributed ledgers (107A, 107B . . . 107N for respective cryptocurrencies) may be associated with the user's cryptocurrency wallet (e.g. wallet module 105).

In turn, the computing device 102 provides an indication of the digital asset identifiers (e.g. a listing indicating digital currency assets held by a user as indicated on the wallet module 105) to the aggregator server 110. Subsequently, the customized feed generator module 322 selects and provides a customized news feed (e.g. feed 111 in FIG. 1) comprising one or more web news articles selected from the database 116 related to (e.g. previously mapped/tagged to) the specific digital assets that have a positive balance in the wallet module 105 for the computing device 102.

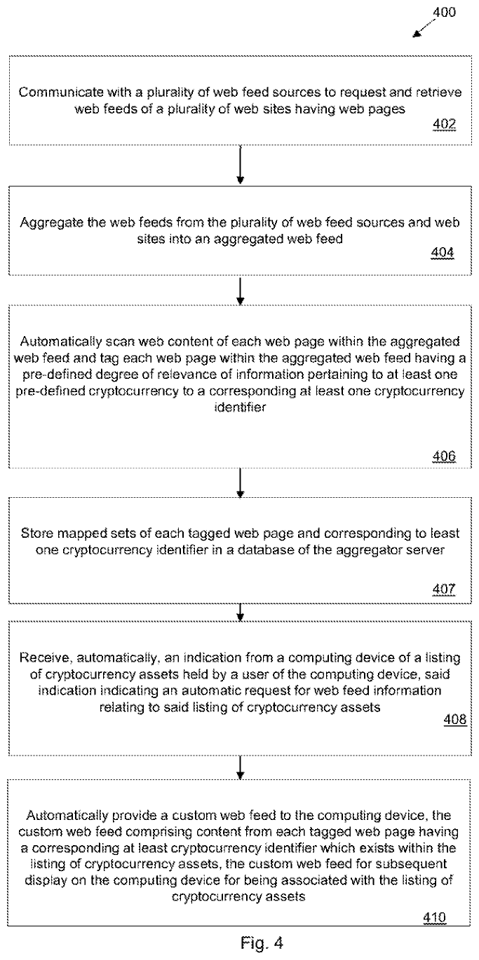

FIG. 4 shows a flowchart of operations 400 of an adaptive news feed generation system utilizing an aggregator server 110 shown in FIGS. 1 and 3, comprising at least one processor 302 in communication with at least one memory (e.g. storage devices 312) and at least one communication subsystem (e.g. communication unit 310). The at least one memory stores instructions, which when executed by the at least one processor 302, configure the aggregator server 110 to perform operations, including operations 400. At step 402, the aggregator server 110 communicates with a plurality of web feed sources to request and retrieve web feeds of a plurality of web sites having web pages. This can include, the aggregator server 110 polling for and/or automatically periodically receiving a set of web feeds (e.g. RSS feeds 113) from a defined RSS feed generator server 112 and/or directly from web sites 114. The set of web feeds may be defined manually (e.g. by specific subscription requests of a user of the computing device 102 to particular newsfeed) and/or automatically (e.g. based on automatic feedback from computing devices 102 relating to web feed content that was most viewed and/or web feeds that were least viewed). For example, the set of web feeds received at the aggregator server 110 could be from all web-based news services that the aggregator server 110 discovers or based on subscription criteria specific to users of the aggregator server 110 (e.g. computing device 102). At step 404, the server Aggregate the web feeds from the plurality of web feed sources and web sites into an aggregated web feed for subsequent analysis. For example, the web feed data from multiple source may thus be aggregated into one location (e.g. the aggregator server 110) and pre-filtered to remove irrelevant web feeds based on machine learning techniques. Optionally, at step 404, the web feeds are merged into a single feed.

As used herein, a “web feed” or a “news feed” refers generally to an XML-based web document which contains content items, such as brief headline summaries of news articles, web log posts and/or web links or more detailed versions of the articles available using a GUI of a computing device to navigate the web feed (e.g. using web news application module 101).

At step 406, the aggregator server 110 automatically scans web content of each web page 114-1, 114-2 to 14-N within the aggregated web feed and tags each web page 114-1, 114-2 to 114-N within the aggregated web feed having a pre-defined degree of relevance of information (e.g. degree of match) pertaining to at least one pre-defined cryptocurrency to a corresponding at least one cryptocurrency identifier. Thus, the aggregated web feed is automatically tagged (e.g. using machine learning and/or pattern recognition techniques as per module 320 in FIG. 3). This includes mapping and tagging each web page 114-1, 114-2 to 14-N or news article within the feed to one or more cryptocurrency identifier symbols based on the content in the news article pertaining to the one or more cryptocurrency associated with the cryptocurrency identifier symbols. As shown in FIG. 1, the tagged news feed is preferably stored in a database 116, which contains a categorized collection of web feeds (e.g. news articles) and associated cryptocurrency identifiers which may be stored in a pre-defined hierarchical structure). At step 407, the aggregator server 110 further stores mapped sets of each tagged web page 114-1, 114-2 to 14-N and corresponding to least one cryptocurrency identifier in a database of the aggregator server 110 (e.g. database 116).

In one aspect, a web feed further includes content and/or web links to content (e.g. provided in an XML stream) including video and/or audio content associated with one or more web sites 114. Aggregator server 110 may be configured to automatically generate a transcript of the video and/or audio content or use text captions (e.g. closed captions) associated with the video/audio content. Subsequently, aggregator server 110 can utilize the transcript or text captions in order to process, screen and tag the video/audio content in the web feed to one or more associated cryptocurrency elements based on similarities in the content to the cryptocurrency element(s), e.g. as determined by the machine learning module 320 of FIG. 3.

At step 408, the aggregator server 110 receives automatically, an indication from a computing device (e.g. computing device 102 of FIG. 1) of a listing of cryptocurrency assets held by a user of the computing device, said indication indicating an automatic request for web feed information relating to said listing of cryptocurrency assets. In this way, the aggregator server 110 is configured to frequently and automatically receive, from the computing device 102, an indication of cryptocurrency content (e.g. content related to specific cryptocurrency assets) that the computing device 102 is interested in receiving. The aggregator server 110 utilizes the tagged feeds generated at step 406 to determine a customized web feed (e.g. containing specific web content that relate to each of the desired cryptocurrency asset(s)) and provides same to the computing device 102 at step 410. Thus, as shown at step 410, the aggregator server 110 automatically provide a custom web feed to the computing device 102. The custom web feed comprises content from each tagged web page 114-1, 114-2 to 14-N having a corresponding at least cryptocurrency identifier which exists within the listing of cryptocurrency assets, the custom web feed for subsequent display on the computing device 102 for being associated with the listing of cryptocurrency assets.

As discussed above, with reference to FIG. 1, the wallet module 105 of the computing device 102 automatically provides a listing of the particular cryptocurrency asset(s) to receive related web content thereto in the forms of a customized adaptive news feed.

In an alternative embodiment, the aggregator server 110 is further configured (e.g. at or prior to step 410) to receive an indication from the computing device 102 of a ratio of each cryptocurrency held by a user on a digital wallet of the computing device 102 relative to a total amount of cryptocurrency held. The aggregator server 110 then weights the amount of web articles related to a particular cryptocurrency asset based on the relative value of the particular cryptocurrency asset to a total amount of digital cryptocurrency assets owned by a user of the computing device 102. For example, if the digital wallet module 105 contains cryptocurrency with the following breakdown: 20% ETH and 80% BTC, then according to the present embodiment, the aggregator server 110 generates a customized news feed (e.g. feed 111) containing 20% ETH-related news and 80% BTC-related news for receipt and subsequent display on computing device 102. In yet another aspect, the aggregator server 110 further orders the web articles for each cryptocurrency asset such that the web articles relating to cryptocurrency assets being held in a larger proportion as compared to others are prioritized for display on the computing device 102.

In yet another alternative embodiment, at step 408, the aggregator server 110 additionally receives manually selected requests for specific content in the web feed (e.g. selected via a GUI such as within web news application module 101). Thus, at step 410, the aggregator server 110 provides both automatically generated news feeds based on cryptocurrency listings held by a user of the wallet module 105 as automatically indicated by the computing device 102 (e.g. without user input) and additional news feeds based on manual input request received from the computing device 102. Accordingly, this allows users of the computing device 102 to select and define specific news streams that they are interested in along with the adaptive news stream generated at step 410.

In one embodiment, the aggregator server 110 is configured (e.g. either directly through a user interface of the aggregator server 110 or via a user interface of the computing device 102) to provide customized news feeds 111 that include web articles relating to previously held cryptocurrency assets. Notably, the aggregator server 110 may slowly decrease, towards zero, the amount of web article entries in the customized news feed 111 relating to cryptocurrencies previously held over a period of time by the user of the computing device 102.

In yet another embodiment, the method 400 of FIG. 4 is modified at step 410 such that a first pre-defined percentage or ratio of news article entries in the customized news feed 111 relate to the cryptocurrency assets currents held by the user of computing device 102 and a remaining percentage or ratio of news article entries in the customized news feed 111 relate to general cryptocurrency news or news relating to new cryptocurrency assets (e.g. not previously held) as discovered by the aggregator server 110.

In yet another embodiment, the web news application module 101 is configured to track clicks or views of articles received in the customized news feed 111 and to request the aggregator server 110 to weight and/or prioritize future web articles in the customized news feed 111 according to the user's interest in viewing such articles as previously defined by the number of clicks or views. For example, if a user of the computing device 102 never reads articles about cryptocurrency ABC (e.g. as determined by web news application module 101) then the web news application module 101 asks the user if they want to drop/reduce articles from the customized news feed 111 or sort them to the end of the customized news feed 111. Such re-sorting may be done directly on computing device 102 or via cooperation with the aggregator server 110. Conversely, if the web news application module 101 determines that a user read a large number of articles received about currency ABC then the web news application module 101 may prompt a user to ask if customized news feed 111 should have more articles about that currency to increase mix, sort to the top, etc. Such information may then be relayed to aggregator server 110 for dynamically adjusting the customized news feed 111 for subsequent feeds based on user input on computing device 102 or user statistics collected on computing device 102 defining degree of interest in particular cryptocurrencies (e.g. by number of clicks or views).

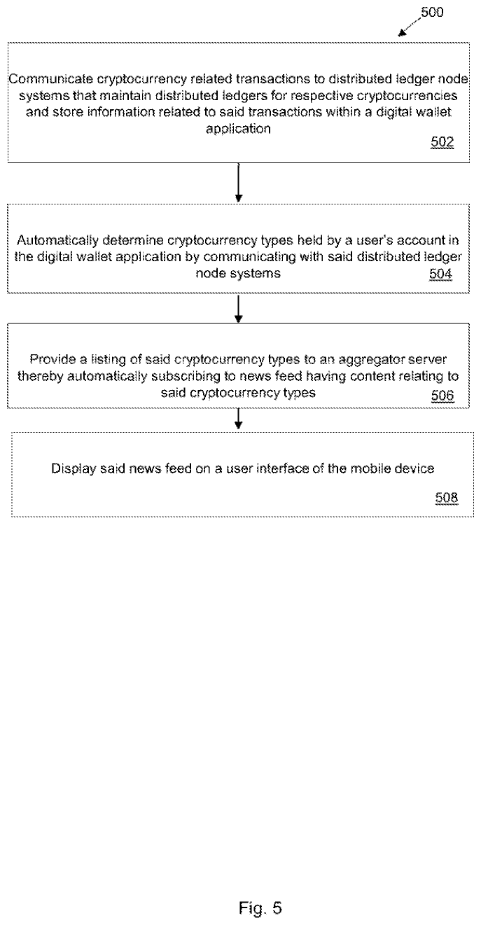

FIG. 5 shows a flowchart of operations 500 of an adaptive news feed generation system utilizing a computing device 102 shown in FIGS. 1 and 2, comprising at least one processor 202 in communication with at least one memory (e.g. storage devices 212) and at least one communication subsystem (e.g. communication unit 208). The at least one memory stores instructions, which when executed by the at least one processor 202, configure the computing device 102 to perform operations, including operations 500. At step 502, the computing device communicates cryptocurrency related transactions to distributed ledger node systems that maintain distributed ledgers for respective cryptocurrencies and store information related to the transactions within a digital wallet application of the computing device 102.

At step 504, at pre-defined time intervals or upon receiving a trigger, the computing device 102 is configured to automatically determine which digital assets (e.g. cryptocurrency types) are held by a user's account in the digital wallet application, e.g. digital wallet module 105, by communicating with said respective distributed ledger node systems 106A, A16B . . . 106N. The trigger may include detecting a cryptocurrency transaction performed by the wallet module 105 and/or be triggered by a user of the computing device 102 to check each of the cryptocurrency types held and their value.

As mentioned above, the wallet module 105 stores private and public keys and interacts with respective blockchains (e.g. distributed ledgers 107A, 107B, . . . 107N) to enable users to send and receive digital cryptocurrency and monitor their balance(s). That is, in at least one aspect, the digital balance is not held directly within the wallet module 105 and needs to be verified by contacting the respective blockchains. Also, as discussed herein, the wallet module 105 is a universal wallet/multi-coin wallet, which can be used to store many different types of cryptocurrency coins.

At step 506, upon determining, by the computing device 102 the digital assets (cryptocurrency types) held and currently owned by the user (e.g. cryptocurrencies A to N) in the wallet module 105, the wallet module 105 is configured to provide a listing of said cryptocurrency types to an aggregator server 110 thereby automatically subscribing to news feed having content relating to said cryptocurrency types for the computing device 102. Thus, the computing device 102 thereby automatically subscribes to and requests web news (e.g. web sites 114) from the aggregator 110 that relates specifically to the user-owned digital cryptocurrency types (e.g. cryptocurrencies A to N). As noted with reference to FIGS. 1 and 4, the aggregator server 110 generates the automatic and adaptively subscribed customized news feed 111 based on the current wallet module 105 balance status. At step 508, the received news feed is displayed on a user interface of the mobile computing device 102.

In one aspect, the operation 500 is modified at step 506 by further determining a relative value of each of the cryptocurrency types held within the digital wallet by communicating with the distributed ledger node systems 106A, 106B . . . 106N. Subsequent to such determination, the computing device 102 automatically provides a request to the aggregator server 110 for an updated news feed having a percentage of content for each of the cryptocurrency types in relation to the relative value for each of the cryptocurrency types and receives the updated news feed for display on the user interface of the mobile device.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

1. An aggregator server for facilitating automatic customized web feed generation, the server having a processor, a communication subsystem and a memory each in communication with the processor, the memory storing instructions, which when executed by the processor, configure the aggregator server to:
receive web feeds of items of content from a plurality of web feed sources and web sites;
automatically scan the content of each item within the web feeds and tag each item in accordance with a relation in the content to one or more pre-defined cryptocurrencies;
automatically receive from a computing device a request for web feed information associated with a listing of cryptocurrencies, the listing determined from cryptocurrency assets managed by the computing device in association with a user of the computing device;
automatically define a custom web feed to comprise items selected from each item as tagged and responsive to the listing of cryptocurrencies; and
automatically communicate the custom web feed to the computing device in response to the request.

2. The aggregator server of claim 1, wherein receiving web feeds further comprises aggregating the web feeds into a single merged feed thereby to scan and parse the items of content for subsequent tagging within the single merged feed.

3. The aggregator server of claim 1, wherein the items of content comprise web content including at least one of: text; images; audio; and animations.

4. The aggregator server of claim 1, wherein the web feeds comprise news feeds.

5. The aggregator server of claim 1, wherein, a format of the web feeds is defined in accordance with at least one of: RSS, Atom, JSON, and raw XML format.

6. The aggregator server of claim 1 further comprising the processor configuring the aggregator server to: select items in the custom web feed for subsequent communication further proportional to respective amounts of cryptocurrency assets managed by the computing device for the user.

7. The aggregator server of claim 1, wherein items in the custom feed are further ordered in response to a ranking of the respective cryptocurrencies according to a value of each particular cryptocurrency to a total value of the cryptocurrency assets in the listing.

8. The aggregator server of claim 1 further configured to: subsequent to providing the custom web feed and upon receiving an input from the computing device indicating a measure of previously viewing or clicking on particular web entries in the custom web feed relating to a first cryptocurrency asset held by the user; updating the content of the custom web feed, for subsequent output, to include subsequent web entries relating to the first cryptocurrency asset in proportion to the measure for previously viewing or clicking on particular web entries for the first cryptocurrency.

9. The aggregator server of claim 1 further configured to: subsequent to communicating the custom web feed and upon receiving an input from the computing device indicating additional topics of interest for the custom web feed; updating the content of the custom web feed, for subsequent output, to include subsequent web entries relating to the additional topics of interest in addition to the custom web feed containing web articles relating to the listing of cryptocurrency assets currently held by the user of the computing device.

10. The aggregator server of claim 9, wherein the additional topics of interest are provided on a user interface of the computing device in the form of one or more first cryptocurrency types not provided in the listing of cryptocurrency assets.

11. The aggregator server of claim 1 wherein automatically scanning the content of each item further comprises: determining the scanned content comprises video content or audio content; automatically generating a transcript of the video content or the audio content and, said step of tagging further comprises: tagging each item to a corresponding at least one cryptocurrency identifier based on content in the transcript indicating a degree of relevance to the at least one cryptocurrency identifier.

12. The aggregator server of claim 1 wherein automatically generating a transcript of the video content comprises extracting closed captions associated with the video content.

13. A mobile device configured for facilitating automatic customized web feed generation, the mobile device having a processor, a communication subsystem and a memory each in communication with the processor, the memory storing instructions, which when executed by the processor, configure the mobile device to:
automatically determine cryptocurrency types held by a user's account in a digital wallet application, stored by the mobile device, for cryptocurrency related transactions;
provide a listing of the cryptocurrency types to an aggregator server thereby automatically subscribing to news feed having items of content relating to said cryptocurrency types; and
display the news feed on a user interface of the mobile device.

14. The mobile device of claim 13, wherein the instructions when executed by the processor, configure the mobile device to: communicate, across a network, cryptocurrency related transactions to distributed ledger node systems that maintain distributed ledgers for respective cryptocurrencies and store information related to the transactions within the digital wallet application.

15. The mobile device of claim 13, wherein the instructions when executed by the processor, configure the mobile device to:
determine a relative value of each of the cryptocurrency types held within the digital wallet by communicating with the distributed ledger node systems;
automatically provide a request to the aggregator server for an updated news feed having a percentage of content for each of the cryptocurrency types in relation to the relative value for each of the cryptocurrency types; and
receive the updated news feed for display on the user interface of the mobile device.

16. The mobile device of claim 13, wherein the instructions when executed by the processor, configure the mobile device to:
receive an input on the user interface of the mobile device for adjusting the content of the newsfeed to include a further cryptocurrency type; and
automatically provide a request to the aggregator server for updating the news feed based on the adjusted content.

17. The mobile device of claim 13, wherein the instructions when executed by the processor, configure the mobile device to:
monitor click-through rates of each article relating to each cryptocurrency type of said cryptocurrency types; and
automatically provide a request to the aggregator server for updating the news feed based on the click-through rates.

18. A computer-implemented method for facilitating automatic customized web feed generation, the method comprising:
communicating with a plurality of web feed sources and web sites to request and retrieve web feeds of items of content;
automatically scanning the content of each item within the web feeds and tagging each item in accordance with a relation in the content to one or more pre-defined cryptocurrencies;
automatically receiving from a computing device a request for web feed information associated with a listing of cryptocurrencies, the listing determined from cryptocurrency assets managed by the computing device in association with a user of the computing device;
automatically defining a custom web feed to comprise items selected from each item as tagged and responsive to the listing of cryptocurrencies; and
automatically communicating the custom web feed to the computing device in response to the request.

19. The method of claim 18, wherein receiving web feeds further comprises aggregating the web feeds into a single merged feed thereby to scan and parse the items of content for subsequent tagging within the single merged feed.

20. The method of claim 18, wherein the items of content comprise web content including at least one of: text; images; audio; and animations.

21. The method of claim 18, wherein the web feeds comprise news feeds.

22. The method of claim 18, wherein, a format of the web feeds is defined in accordance with at least one of: RSS, Atom, JSON, and raw XML format.

23. The method of claim 18 further comprising the processor configuring the aggregator server to: select items in the custom web feed for subsequent communication further proportional to respective amounts of cryptocurrency assets managed by the computing device for the user.

24. The method of claim 18, wherein items in the custom feed are further ordered in response to a ranking of the respective cryptocurrencies according to a value of each particular cryptocurrency to a total value of the cryptocurrency assets in the listing.

25. The method of claim 18 further configured to: subsequent to providing the custom web feed and upon receiving an input from the computing device indicating a measure of previously viewing or clicking on particular web entries in the custom web feed relating to a first cryptocurrency asset held by the user; updating the content of the custom web feed, for subsequent output, to include subsequent web entries relating to the first cryptocurrency asset in proportion to the measure for previously viewing or clicking on particular web entries for the first cryptocurrency.

26. The method of claim 18 further configured to: subsequent to communicating the custom web feed and upon receiving an input from the computing device indicating additional topics of interest for the custom web feed; updating the content of the custom web feed, for subsequent output, to include subsequent web entries relating to the additional topics of interest in addition to the custom web feed containing web articles relating to the listing of cryptocurrency assets currently held by the user of the computing device.

27. The method of claim 26, wherein the additional topics of interest are provided on a user interface of the computing device in the form of one or more first cryptocurrency types not provided in the listing of cryptocurrency assets.

28. The method of claim 18 wherein automatically scanning the content of each item further comprises: determining the scanned content comprises video content or audio content;
automatically generating a transcript of the video content or the audio content and, said step of tagging further comprises: tagging each item to a corresponding at least one cryptocurrency identifier based on content in the transcript indicating a degree of relevance to the at least one cryptocurrency identifier.

29. The method of claim 18 wherein automatically generating a transcript of the video content comprises extracting closed captions associated with the video content.

30. An adaptive web based news feed system for automatically providing a customized web news feed related to digital assets held by a user of a computing device, the system comprising:
an aggregator server configured to automatically subscribe the computing device to a custom news feed having content relating to cryptocurrency types specified in a listing of cryptocurrency assets and to update the custom news feed based upon a second listing of the cryptocurrency types provided at a subsequent time; and
the computing device configured to:
automatically determine cryptocurrency types held by a user's account in a digital wallet application, stored by the computing device, for cryptocurrency related transactions; and
provide a listing of the cryptocurrency types to the aggregator server.
